(19) United States
(12) Patent Application Publication
(10) Pub. No.: US 2025/0385520 A1
(43) Pub. Date: Dec. 18, 2025

(54) POWER TRANSMISSION AND DISTRIBUTION OPERATIONS MANAGEMENT APPARATUS, POWER SYSTEM OPERATION MANAGEMENT SYSTEM, POWER SYSTEM OPERATION MANAGEMENT METHOD, AND STORAGE MEDIUM

(71) Applicant: Mitsubishi Electric Corporation, Chiyoda-ku, Tokyo (JP)

(72) Inventor: Nobuhiko ITAYA, Tokyo (JP)

(73) Assignee: Mitsubishi Electric Corporation, Chiyoda-ku, Tokyo (JP)

(21) Appl. No.: 18/877,320

(22) PCT Filed: Jul. 5, 2022
(86) PCT No.: PCT/JP2022/026711

§ 371 Date: Dec. 20, 2024

(51) Int. Cl. H02J 3/12; H02J 3/00; H02J 3/18; H02J 13/00

(52) U.S. Cl. CPC H02J 3/12; H02J 3/003; H02J 3/004; H02J 3/1878; H02J 13/00006; H02J 13/00036; H02J 2203/10

(57) ABSTRACT

A power transmission and distribution operations management system according to the present disclosure includes a node and branch integration unit that generates integrated installation data including both installations in a transmission system and installations in a distribution system, using transmission system installation data that are data about the installations in the transmission system and distribution system installation data that are data about the installations in the distribution system; and a power flow calculation unit that determines control quantities for the installations in the transmission system and the distribution system, using the integrated installation data, power supply and demand forecast data within the transmission system, and power supply and demand forecast data within the distribution system, for compliance with at least one of a current constraint or a voltage constraint.

### FIELD

The present disclosure relates to a power transmission and distribution operations management apparatus, a power system operation management system, a power system operation management method, and a program for managing a power system.

### BACKGROUND

A power system has a hierarchical structure where plural distribution systems are interconnected to a transmission system. The transmission system and the distribution systems are operated separately, with individual computer systems (installation planning systems, operation planning systems, and monitoring control systems) provided for the transmission and distribution systems to support operation of the power system.

Proposed in Patent Literature 1, for example, is a method for centralized control of voltage in a distribution system that is consistent throughout the distribution system (hereinafter referred to as the centralized control method). The technique described in Patent Literature 1 involves controlling voltage control devices in the distribution system, allowing for prevention of voltage deviations from proper ranges within the distribution system.

### CITATION LIST

### Patent Literature

Patent Literature 1: Japanese Patent Application Laid-open No. 2013-78237

### SUMMARY OF INVENTION

### Problem to be Solved by the Invention

However, the control provided by the technique described in Patent Literature 1 is confined within the distribution system, not considering the transmission system. In recent years, increasing interconnection of distributed power supplies, such as photovoltaic systems and storage batteries, with the transmission and distribution systems has caused problems, such as voltage violations (voltage deviations from proper ranges) and overloads, to be more obvious. Whether distributed power supplies are interconnected with the transmission system (for extra-high voltage consumers in Japan) or the distribution systems, power quality problems like voltage violations and overloads affect the entire power system. As mentioned earlier, the transmission system and the distribution systems are currently operated separately, limiting the ability to solve the problems.

The present disclosure has been made in view of the above, and an object of the present disclosure is to obtain a power transmission and distribution operations management apparatus that allows for enhancement of the ability to solve the power quality problems in the power system.

### Means to Solve the Problem

In order to solve the above-described problems and achieve the object, a power transmission and distribution operations management apparatus according to the present disclosure includes an integration unit to generate integrated installation data including both installations in a transmission system and installations in a distribution system, using transmission system installation data and distribution system installation data, the transmission system installation data being data about the installations in the transmission system, the distribution system installation data being data about the installations in the distribution system. The power transmission and distribution operations management apparatus further includes a control quantity determination unit to determine control quantities for the installations in the transmission system and the distribution system, using the integrated installation data, power supply and demand forecast data within the transmission system, and power supply and demand forecast data within the distribution system, for compliance with at least one of a current constraint or a voltage constraint.

### Effects of the Invention

A power transmission and distribution operations management apparatus according to the present disclosure has an effect of enhancing the ability to solve power quality problems in a power system.

### BRIEF DESCRIPTION OF DRAWINGS

FIG. 1 is a diagram illustrating an exemplary configuration of a power system operation management system according to a first embodiment.

FIG. 2 is a diagram illustrating an example of a power system that the power system operation management system according to the first embodiment manages.

FIG. 3 is a schematic diagram illustrating a concept of optimal power flow calculation according to the first embodiment.

FIG. 4 is a flowchart illustrating an example of a power flow calculation process according to the first embodiment.

FIG. 5 is a flowchart illustrating the example of the power flow calculation process according to the first embodiment.

FIG. 6 is a diagram illustrating an exemplary configuration of a computer system that implements a power transmission and distribution operations management system according to the first embodiment.

FIG. 7 is a flowchart illustrating an example of a power flow calculation process according to a second embodiment.

FIG. 8 is a flowchart illustrating the example of the power flow calculation process according to the second embodiment.

### DESCRIPTION OF EMBODIMENTS

With reference to the drawings, a detailed description is hereinafter provided of power transmission and distribution operations management apparatuses, power system operation management systems, power system operation management methods, and programs according to embodiments.

### First Embodiment

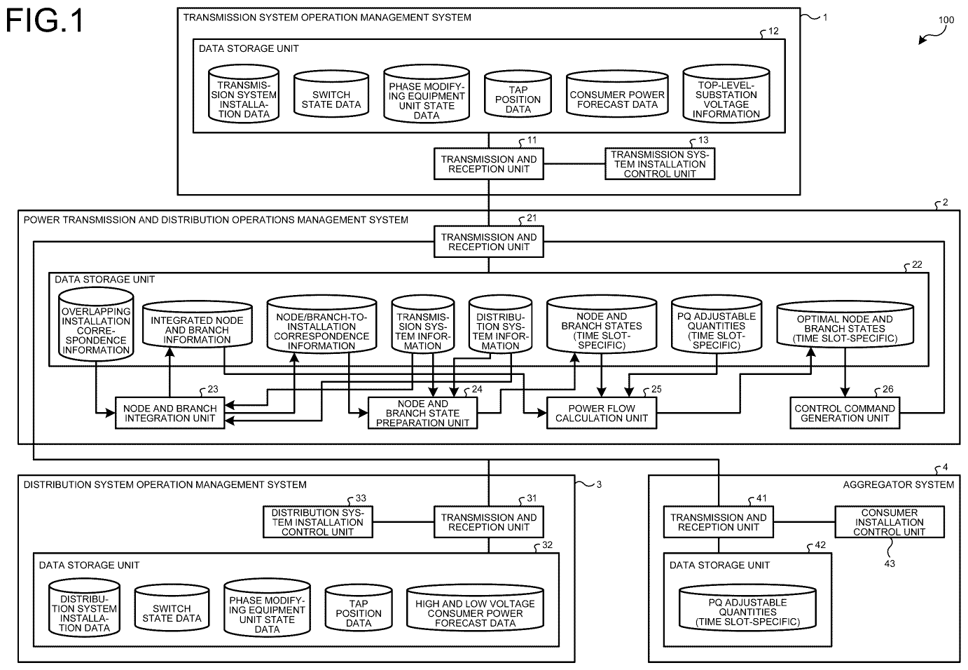

FIG. 1 is a diagram illustrating an exemplary configuration of a power system operation management system according to a first embodiment. The power system operation management system 100 according to the present embodiment includes a transmission system operation management system 1, a power transmission and distribution operations management system 2, and a distribution system operation management system 3. The power system operation management system 100 may also include an aggregator system 4.

The transmission system operation management system 1 manages installations in a transmission system. Specifically, the transmission system operation management system 1 manages primary-side buses of distribution substations and higher-level installations. The distribution system operation management system 3 manages installations in distribution systems. Specifically, the distribution system operation management system 3 manages the primary-side buses of the distribution substations and lower-level installations. The aggregator system 4 uses installations of consumers to control power generation and power demand, such as in a virtual power plant (VPP) and demand response (DR). The consumers that the aggregator system 4 manages include low voltage consumers, high voltage consumers, and extra-high voltage consumers. The low voltage consumers refer to consumers having installations connected to low-voltage distribution lines with 100V and 200V, for example. The high voltage consumers refer to consumers having installations connected to high-voltage distribution lines with 6,600 V, for example. The extra-high voltage consumers refer to consumers having installations along extra-high-voltage transmission lines exceeding 70,000 V, such as 154,000 V. These voltage values of the distribution and transmission lines are examples and are not limiting.

The power transmission and distribution operations management system 2, which is a power transmission and distribution operations management apparatus, obtains transmission system information including various data about the transmission system from the transmission system operation management system 1 and obtains distribution system information including various data about the distribution systems from the distribution system operation management system 3. Furthermore, the power transmission and distribution operations management system 2 obtains controllable quantities of active power and reactive power (PQ adjustable quantities) of the consumer installations from the aggregator system 4. The power transmission and distribution operations management system 2 uses the transmission system information, the distribution system information, and the PQ adjustable quantities to perform optimal power flow (OPF) calculation across an entire power system, which includes the transmission system and the distribution systems, for calculating control quantities for the installations in the power system (the installations in the transmission system, the installations in the distribution systems, and the consumer installations) and preparing a control plan (installation operation plan). In this way, the ability to solve power quality problems in the power system can be enhanced compared to when the transmission system and the distribution systems are operated separately.

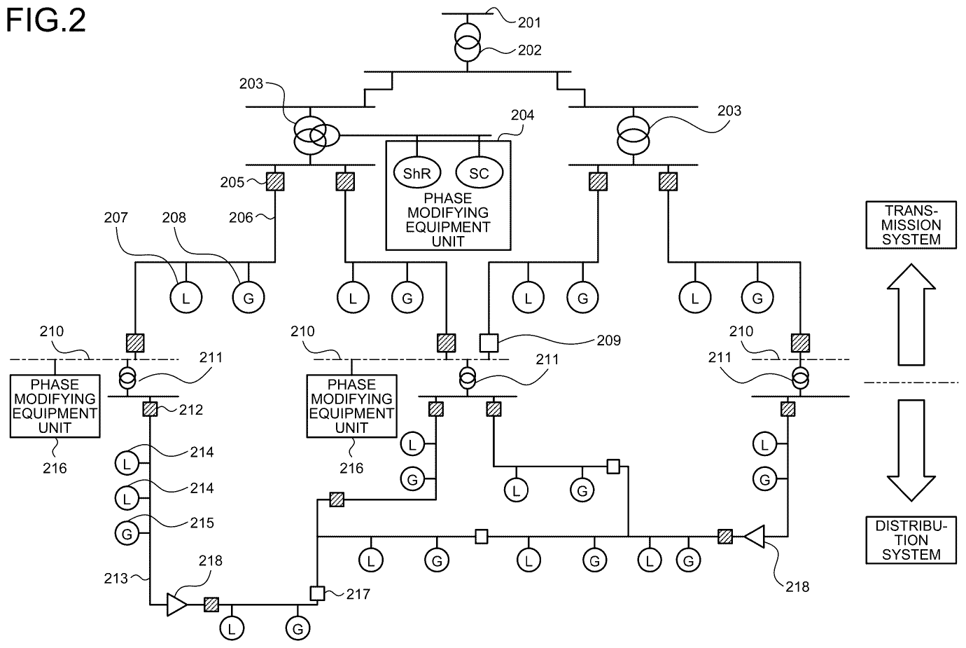

FIG. 2 is a diagram illustrating an example of the power system that the power system operation management system 100 according to the present embodiment manages. The power system illustrated as the example in FIG. 2 includes a transmission system extending from a top-level-substation primary-side bus 201, which is a primary-side bus of a top-level substation, to distribution-substation primary-side buses 210, which are primary-side buses of distribution substations, and distribution systems extending from the distribution-substation primary-side buses 210 to low-voltage distribution lines (not illustrated). The distribution-substation primary-side buses 210 are included in both the transmission system and the distribution systems as overlapping installations. In FIG. 2, the overlapping installations are indicated by dot-and-dash lines.

The transmission system includes a top-level transformer 202 connected to the top-level-substation primary-side bus 201, transmission transformers 203, transmission switches 205 and 209, which are switches in the transmission system, a transmission line 206, and a phase modifying equipment unit 204. The top-level transformer 202 is a transformer of the top-level substation. The transmission transformers 203 are connected to a secondary-side bus of the top-level transformer 202 and convert an ultrahigh voltage (e.g., 220,000 V to 275,000 V) from the top-level transformer 202 to the extra-high voltage. Although both the transmission switch 205 and the transmission switch 209 are the switches in the transmission system, the transmission switch 205 is in an ON or closed state, while the transmission switch 209 is in an OFF or open state. It is to be noted that any figures hatched and shaped similarly to the transmission switch 205 in the transmission system denote transmission switches in the ON state. In FIG. 2, the transmission switches are illustrated in the ON or OFF states (open/closed states) as examples. The transmission switches can be switched between the ON and OFF states through switching operations.

The phase modifying equipment unit 204 includes, for example, at least one shunt reactor (abbreviated as ShR in the drawing) and at least one phase advancing capacitor (static capacitor abbreviated as SC in the drawing). The phase modifying equipment unit 204 may include either the shunt reactor(s) or the phase advancing capacitor(s). When the phase modifying equipment unit 204 includes plural phase advancing capacitors, each of the phase advancing capacitors can be individually set to an ON or OFF state. When the phase modifying equipment unit 204 includes plural shunt reactors, each of the shunt reactors can be individually set to an ON or OFF state.

Connected to the transmission line 206 are a load (abbreviated as L in the drawing) 207 of an extra-high voltage consumer and a power generation installation (abbreviated as G in the drawing) 208 of the extra-high voltage consumer. Lines connected to the transmission switches 205 are also transmission lines 206 that are identical to the transmission line 206 but without reference characters, and Ls and Gs connected to the transmission lines 206 without the reference characters in the drawing are also loads 207 and power generation installations 208 of extra-high voltage consumers.

The distribution systems include the distribution-substation primary-side buses 210, distribution transformers 211 connected to the distribution-substation primary-side buses 210, distribution switches 212 and 217, which are switches in the distribution systems, a distribution line 213, phase modifying equipment units 216, and step voltage regulators (SVRs) 218, which are transformer-type voltage regulators. The distribution transformer 211 converts the extra-high voltage to a high voltage and supplies the distribution line 213 with the high voltage. Although both the distribution switch 212 and the distribution switch 217 are the switches in the distribution systems, the distribution switch 212 is in the ON or closed state, while the distribution switch 217 is in the OFF or open state. It is to be noted that in the distribution systems, any figures hatched and shaped similarly to the distribution switch 212 denote distribution switches in the ON state, while any figures with the same shape as the distribution switch 217 denote distribution switches in the OFF state. In FIG. 2, the distribution switches are illustrated in the ON or OFF states (open/closed states) as examples. The distribution switches can be switched between the ON and OFF states through switching operations.

Each of the phase modifying equipment units 216 includes, for example, at least one shunt reactor and at least one phase advancing capacitor, as with the phase modifying equipment unit 204. Each phase modifying equipment unit 216 may include either the shunt reactor(s) or the phase advancing capacitor(s). When each phase modifying equipment unit 216 includes plural phase advancing capacitors, each of the phase advancing capacitors can be individually set to the ON or OFF state. When each phase modifying equipment unit 216 includes plural shunt reactors, each of the shunt reactors can be individually set to the ON or OFF state.

Connected to the distribution line 213 are loads (abbreviated as Ls in the drawing) 214 of high or low voltage consumers and a power generation installation (abbreviated as G in the drawing) 215 of the high or low voltage consumer. Lines connected to the distribution switches 217 are also distribution lines 213 that are identical to the distribution line 213 but without reference characters, and Ls and Gs connected to the distribution lines 213 without the reference characters in the drawing are also loads 214 and power generation installations 215 of high and low voltage consumers. If a load 214 is an installation of a low voltage consumer, the load 214 is connected to a low-voltage distribution line connected to a transformer (not illustrated), such as a pole-mounted transformer. If a power generation installation 215 is an installation of a low voltage consumer, the power generation installation 215 is connected to a low-voltage distribution line connected to a transformer (not illustrated), such as a pole-mounted transformer. The transformer, such as the pole-mounted transformer, converts the high voltage to the lower voltage, and installations of low voltage consumers are grouped herein into one node for each transformer, meaning that such loads 214 and power generation installations 215 illustrated in FIG. 2 are grouped on a per-transformer basis (e.g., for each pole-mounted transformer).

It is to be noted that FIG. 2 illustrates the example. The count, arrangement, and other details of each installation in the exemplary configuration illustrated in FIG. 2 are not limiting, and the power system that the power system operation management system 100 according to the present embodiment manages only needs to be a power system that includes a transmission system and a distribution system.

A return is made to the description of FIG. 1. As illustrated in FIG. 1, the transmission system operation management system 1 includes a transmission and reception unit 11, a data storage unit 12, and a transmission system installation control unit 13.

The transmission and reception unit 11 communicates with other units. For example, the transmission and reception unit 11 transmits and receives data to and from the power transmission and distribution operations management system 2. The data storage unit 12 stores the transmission system information. The transmission system information includes, for example, transmission system installation data, switch state data, phase modifying equipment unit state data, tap position data, consumer power forecast data (power supply and demand forecast data within the transmission system), and top-level-substation voltage information.

The transmission system installation data included in the transmission system information are data indicative of the various installations in the transmission system and include, for example, information about the installations in the transmission system, such as the top-level transformer 202, the transmission transformers 203, the various buses, the transmission switches, the phase modifying equipment unit 204, and the consumer installations. For example, the transmission system installation data include installation identification information (installation Identifiers (IDs)), installation types, impedances, and connection information (information indicating which installation(s) each installation is connected to). Furthermore, the transmission system installation data include information indicating the number of phase advancing capacitors and the number of shunt reactors for the phase modifying equipment unit 204.

The switch state data included in the transmission system information include time slot-specific planned values for the open or closed states of the transmission switches. Each time slot is one of divisions of one day and refers to, for example, a time interval with a unit time of 30 minutes. While the unit time is 30 minutes in an example to be described below, the unit time is not limited to 30 minutes. The phase modifying equipment unit state data included in the transmission system information include time slot-specific planned values for connection quantities of the phase advancing capacitor(s) and the shunt reactor(s). The connection quantity may be the product of the number of connected phase advancing capacitors or shunt reactors and capacity (kVar) or may be information indicating the number of connected phase advancing capacitors or shunt reactors and the capacity per unit. The tap position data include time slot-specific planned values for tap positions of the top-level transformer 202 and the transmission transformers 203.

The consumer power forecast data included in the transmission system information include information indicating forecasted power consumption (actual load) results for the loads 207 of the extra-high voltage consumers and information indicating forecasted power generation results for the power generation installations 208 of the extra-high voltage consumers. The forecasted results are time slot-specific information. While the unit time is 30 minutes in the example to be described below, the unit time is not limited to 30 minutes. The actual load and power generation forecasts are based on, for example, actual values; however, this is not limiting, and any forecasting method may be used. In general, for transmission system operation management, actual load and power generation forecasts within the transmission system are made for the next day, the next week, the next month, and the year, and these values can be used as the consumer power forecast data.

The top-level-substation voltage information includes a primary-side voltage curve representing time slot-specific forecasted voltage values for the top-level transformer 202 of the top-level substation. The primary-side voltage curve for the top-level transformer 202 is determined on the basis of, for example, measured values; however, this is not limiting.

Upon receiving control commands from the power transmission and distribution operations management system 2 via the transmission and reception unit 11, the transmission system installation control unit 13 controls the installations in the transmission system on the basis of the received control commands. For example, on the basis of the control commands, the transmission system installation control unit 13 generates control signals corresponding to the installations, such as the top-level transformer 202, the transmission transformers 203, the transmission switches, and the phase modifying equipment unit 204. The transmission system installation control unit 13 transmits the generated control signals to locations, such as corresponding substations, thus controlling the installations in the transmission system. If an installation is operated remotely, a control signal is transmitted to a remote operation system. If an installation is operated manually, the transmission system installation control unit 13 presents a worker with operation details by displaying the operation details on a display unit or the worker's terminal, neither of which is illustrated.

As illustrated in FIG. 1, the distribution system operation management system 3 includes a transmission and reception unit 31, a data storage unit 32, and a distribution system installation control unit 33. In the example illustrated in FIG. 2, where the three distribution transformers 211 are illustrated, the distribution system operation management system 3 is described to manage the three distribution systems corresponding respectively to the three distribution transformers 211. However, the three distribution systems may be managed by a plurality of the distribution system operation management systems 3. For example, the distribution system operation management systems 3 may be provided for the distribution systems, respectively.

The transmission and reception unit 31 communicates with other units. For example, the transmission and reception unit 31 transmits and receives data to and from the power transmission and distribution operations management system 2. The data storage unit 32 stores the distribution system information. The distribution system information includes, for example, distribution system installation data, switch state data, phase modifying equipment unit state data, tap position data, and high and low voltage consumer power forecast data (power supply and demand forecast data within the distribution systems).

The distribution system installation data included in the distribution system information are data about the various installations in the distribution systems and include, for example, information about the installations in the distribution systems, such as the distribution transformers 211, the various buses, the distribution switches, the phase modifying equipment units 216, the SVRs 218, and the consumer installations. For example, the distribution system installation data include installation identification information (installation IDs), installation types, impedances, and connection information (information indicating which installation(s) each installation is connected to). Furthermore, the distribution system installation data include information indicating the number of phase advancing capacitors and the number of shunt reactors for each of the phase modifying equipment units 216.

The switch state data included in the distribution system information include time slot-specific planned values for the open or closed states of the distribution switches. The phase modifying equipment unit state data included in the distribution system information include time slot-specific planned values for connection quantities of the phase advancing capacitor(s) and the shunt reactor(s). The connection quantity may be the product of the number of connected phase advancing capacitors or shunt reactors and capacity (kVar) or may be information indicating the number of connected phase advancing capacitors or shunt reactors and the capacity per unit. The tap position data include time slot-specific planned values for tap positions of the distribution transformers 211 and the SVRs 218.

The high and low voltage consumer power forecast data included in the distribution system information include information indicating forecasted power consumption (actual load) results for the loads 214 of the high and low voltage consumers and information indicating forecasted power generation results for the power generation installations 215 of the high and low voltage consumers. The forecasted results are time slot-specific information. The actual load and power generation forecasts are based on, for example, actual values; however, this is not limiting, and any forecasting method may be used. In general, for distribution system operation management, actual load and power generation forecasts within the distribution systems are made for the next day, the next week, the next month, and the year, and these values can be used as the high and low voltage consumer power forecast data.

Upon receiving control commands from the power transmission and distribution operations management system 2 via the transmission and reception unit 31, the distribution system installation control unit 33 controls the installations in the distribution systems, such as the distribution transformers 211, the distribution switches, and the phase modifying equipment units 216. For example, the distribution system installation control unit 33 generates control signals based on the control commands and transmits the generated control signals to the distribution transformers 211, the distribution switches, and the phase modifying equipment units 216, thus controlling the installations in the distribution systems. If an installation is operated remotely, a control signal is transmitted to a remote operation system. If an installation is operated manually, the distribution system installation control unit 33 presents a worker with operation details by displaying the operation details on a display unit or the worker's terminal, neither of which is illustrated.

As illustrated in FIG. 1, the aggregator system 4 includes a transmission and reception unit 41, a data storage unit 42, and a consumer installation control unit 43.

The transmission and reception unit 41 communicates with other units. For example, the transmission and reception unit 41 transmits and receives data to and from the power transmission and distribution operations management system 2. The data storage unit 42 stores the PQ adjustable quantities of the consumers. The PQ adjustable quantities represent time slot-specific adjustable quantities of the active power and the reactive power. For example, the PQ adjustable quantities are specified on a per-consumer basis for the extra-high voltage consumers and the high voltage consumers, whereas for the low voltage consumers, the PQ adjustable quantities are specified for each transformer that converts the high voltage to the low voltage (e.g., for each pole-mounted transformer). The PQ adjustable quantities are specified, for example, through a contract between an aggregator managing the aggregator system 4 and each consumer; however, this example is not limiting. For example, the aggregator system 4 may determine the PQ adjustable quantities based on the contract and past results with each consumer.

The consumer installation control unit 43 controls the consumer installations via the transmission and reception unit 41. For example, on the basis of control commands, the consumer installation control unit 43 generates control signals to control the consumer installations and transmits the generated control signals to the consumer installations.

The power transmission and distribution operations management system 2 includes a transmission and reception unit 21, a data storage unit 22, a node and branch integration unit 23, a node and branch state preparation unit 24, a power flow calculation unit 25, and a control command generation unit 26.

The transmission and reception unit 21 communicates with other units. For example, the transmission and reception unit 21 receives from the transmission system operation management system 1 the transmission system information (the transmission system installation data, the switch state data, the phase modifying equipment unit state data, the tap position data, the consumer power forecast data, and the top-level-substation voltage information) and stores the received transmission system information in the data storage unit 22. Furthermore, the transmission and reception unit 21 receives from the distribution system operation management system 3 the distribution system information (the distribution system installation data, the switch state data, the phase modifying equipment unit state data, the tap position data, and the high and low voltage consumer power forecast data) and stores the received distribution system information in the data storage unit 22. Furthermore, the transmission and reception unit 21 receives the PQ adjustable quantities from the aggregator system 4 and stores the received PQ adjustable quantities in the data storage unit 22.

As mentioned earlier, the switch state data, the phase modifying equipment unit state data, the tap position data, the consumer power forecast data, the high and low voltage consumer power forecast data, the top-level-substation voltage information, and the PQ adjustable quantities are time slot-specific information. When, for example, the power transmission and distribution operations management system 2 works out a control plan for the installations in the transmission and distribution systems for the entire next day, the power transmission and distribution operations management system 2 obtains time slot-specific data for the entire next day from the transmission system operation management system 1, the distribution system operation management system 3, and the aggregator system 4. In the example to be described below, a target period for which a control plan is worked out is the entire next day; however, the target period for which the control plan is worked out may be the next week, the next month, the next year, or any other period, not being limited to the entire next day.

The node and branch integration unit 23 is an integration unit that uses the transmission system installation data and the distribution system installation data to generate integrated node and branch information (integrated installation data) that includes both the installations of the transmission system and the installations of the distribution systems. Specifically, the node and branch integration unit 23 generates the integrated node and branch information, using the transmission system installation data, which are included in the transmission system information stored in the data storage unit 22, the distribution system installation data, which are included in the distribution system information stored in the data storage unit 22, and overlapping installation correspondence information, which is stored in the data storage unit 22. The node and branch integration unit 23 stores the generated integrated node and branch information in the data storage unit 22. The overlapping installation correspondence information is information indicating the overlapping installations between the transmission system and the distribution systems. The overlapping installation correspondence information is set, for example, by an operator or another person and stored in the data storage unit 22. In the example illustrated in FIG. 2, the distribution-substation primary-side buses 210 are the overlapping installations; therefore, a transmission system-side installation ID and a distribution system-side installation ID of each of the distribution-substation primary-side buses 210, for example, are stored as the overlapping installation correspondence information.

More specifically, using the overlapping installation correspondence information, the node and branch integration unit 23 ascertains which installations in the distribution systems correspond to the overlapping installations in the transmission system and which installations in the distribution systems are connected to the overlapping installations, thus connecting the installations in the transmission system with the installations in the distribution systems. In this way, the node and branch integration unit 23 integrates the installations of the transmission system and the installations of the distribution systems. Using the integrated installations, the node and branch integration unit 23 represents the buses, the consumer installations, and branch points as nodes and represents the transmission lines 206, the distribution lines 213, the transformers (the top-level transformer 202, the transmission transformers 203, and the distribution transformers 211), and the switches (the transmission switches and the distribution switches) as branches, thus generating the integrated node and branch information indicating the integrated nodes and branches. The generated integrated node and branch information is stored in the data storage unit 22. The integrated node and branch information, which refers to the integrated installation data including both the installations of the transmission system and the installations of the distribution systems, indicates which installation each node or branch corresponds to. The impedances of the transmission lines 206, the distribution lines 213, and the transformers are also held as integrated node and branch data. Among the consumers, each of the extra-high voltage consumers is represented as one node, while the low voltage consumers are grouped into one node for each transformer that converts the low voltage to the high voltage (e.g., for each pole-mounted transformer). While the consumer installations are generally classified into the loads and the generators, the consumer installations are treated simply as consumer nodes without being distinguished in this processing.

Using the switch state data, the phase modifying equipment unit state data, the tap position data, the consumer power forecast data, and the top-level-substation voltage information from the transmission system information, the switch state data, the phase modifying equipment unit state data, the tap position data, and the high and low voltage consumer power forecast data from the distribution system information, and node and branch-to-installation correspondence information, the node and branch state preparation unit 24 prepares node and branch states indicating time slot-specific states of the nodes and the branches and stores the prepared node and branch states in the data storage unit 22. The node and branch states are used as initial values in a process that is performed by the power flow calculation unit 25, which will be described later. If any of the switch state data, the phase modifying equipment unit state data, the tap position data, the consumer power forecast data, or the top-level-substation voltage information of the transmission system information or the switch state data, the phase modifying equipment unit state data, the tap position data, or the high and low voltage consumer power forecast data of the distribution system information have not been obtained, the node and branch state preparation unit 24 may, for example, set the missing data to specified initial values or determine the missing data on the basis of past results.

The power flow calculation unit 25 is a control quantity determination unit that uses the integrated node and branch information (integrated installation data), the consumer power forecast data within the transmission system, and the high and low voltage consumer power forecast data within the distribution system to determine control quantities for the installations in the transmission and distribution systems for compliance with at least one of a current constraint providing that current should be within an allowable limit or a voltage constraint providing that the voltage should be within an allowable limit. As mentioned earlier, the consumer power forecast data and the high and low voltage consumer power forecast data are reflected in the node and branch states. Specifically, using the integrated node and branch information and the node and branch states, the power flow calculation unit 25 performs power flow calculation for each time slot, that is to say, for each time section of the control plan's target period. If there are any overloads or voltage violations, the power flow calculation unit 25 performs optimal power flow calculation that involves turning on and off the switches (transmission and distribution switches), changing the tap positions of the transformers, changing the connection quantities of the phase modifying equipment units, and adjusting the active and reactive power (PQ) of the consumer installations to prevent overloads or voltage violations. Through the optimal power flow calculation, the power flow calculation unit 25 determines optimal node and branch states. The power flow calculation unit 25 stores the determined optimal node and branch states in the data storage unit 22. The overload refers to deviation of the current from the allowable limit in any one of the components, such as the transmission lines 206, the distribution lines 213, the transformers (the top-level transformer 202, the transmission transformers 203, and the distribution transformers 211), and the switches (the transmission switches and the distribution switches). The voltage violation refers to deviation of the consumer voltage from the allowable limit. A detailed description of the process performed by the power flow calculation unit 25 will be provided later. The transmission switches and the distribution switches are hereinafter referred to as the switches when not distinguished. The top-level transformer 202, the transmission transformers 203, and the distribution transformers 211 are hereinafter referred to as the transformers when not distinguished.

On the basis of the optimal node and branch states, the control command generation unit 26 generates the control commands for the open/closed states of the switches, the tap positions of the transformers, and the PQ adjustment quantities of the consumers. The control command generation unit 26 sorts and transmits the generated control commands to the transmission system operation management system 1, the distribution system operation management system 3, and the aggregator system 4. Specifically, the control command generation unit 26 transmits the control commands for the open/closed states of the transmission switches and the tap positions of the transformers in the transmission system to the transmission system operation management system 1. The control command generation unit 26 transmits the control commands for the open/closed states of the distribution switches and the tap positions of the transformers in the distribution systems to the distribution system operation management system 3. The control command generation unit 26 transmits the control commands for the PQ adjustment quantities of the consumers to the aggregator system 4.

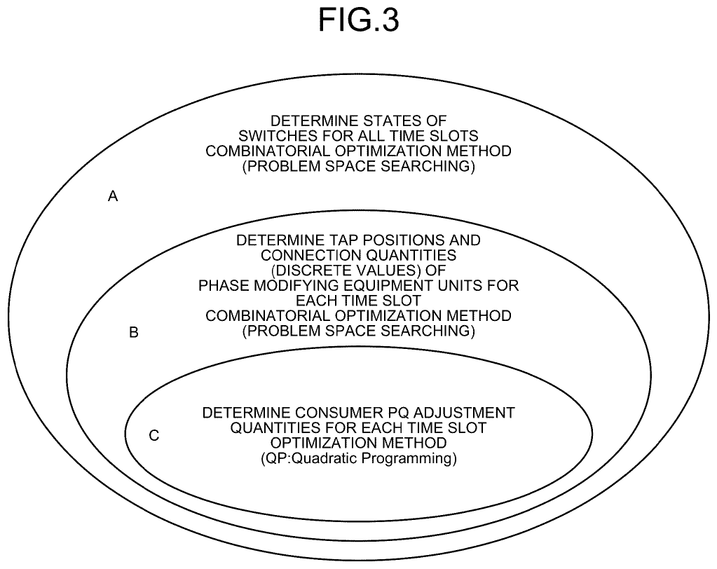

A description is provided next of the optimal power flow calculation according to the present embodiment. FIG. 3 is a schematic diagram illustrating a concept of the optimal power flow calculation according to the present embodiment. In the present embodiment, variables in the optimal power flow calculation are, for example, hierarchized, as illustrated in FIG. 3.

The variables in the optimal power flow calculation include changes to the open/closed states of the switches, changes to the tap positions of the transformers (including the SVRs 218), changes to the connection quantities of the phase modifying equipment units, and the PQ adjustment quantities of the consumer installations (hereinafter also referred to as the consumer PQ adjustment quantities). In general, when solving an optimization problem, a combinatorial optimization method (problem space searching) is used to determine values for discrete variables, the variables that take on discrete values, while an optimization method, such as quadratic programming (QP), is used to determine values for continuous variables, the variables that take on continuous values. The open/closed states of the switches, the tap positions of the transformers, and the connection quantities of the phase modifying equipment units are discrete variables, while the consumer PQ adjustment quantities are continuous variables. When solving an optimization problem with a mixture of discrete and continuous variables, common overall optimization is as follows. The discrete variables are generally placed in an outer loop, and with the discrete variables tentatively determined, the continuous variables are optimized through an inner process. Afterward, changes are made to the discrete variables, and the inner process is repeated.

In the present embodiment as well, the discrete variables are placed in the outer loop; however, in the present embodiment, the discrete variables are further divided into a sub-loop for the open/closed states of the switches and a sub-loop for the tap positions and the connection quantities (discrete values) of the phase modifying equipment units, resulting in a three-level hierarchical structure, as illustrated in FIG. 3. Recently, the interconnection of photovoltaic systems (hereinafter abbreviated as PVs) has increased, raising concerns about significant power flow variations due to daytime PV output fluctuations in systems with many interconnected PVs. For this reason, changing the open/closed states of the switches should preferably be avoided during the daytime, and performing this operation multiple times a day is undesirable. Therefore, the open/closed states of the switches are kept unchanged throughout the day, and changes are made to the open/closed states on a daily basis here. Accordingly, the open/closed states are set to remain the same for a one-day period, being separated from the tap positions and the connection quantities (discrete values) of the phase modifying equipment units here. Specifically, process A for determining the switch states (the open/closed states of the switches) for all the time slots is performed using the combinatorial optimization method (problem space searching). Process B for determining the tap positions and connection quantities (discrete values) of the phase modifying equipment units for each time slot is performed using the combinatorial optimization method (problem space searching). Process C for determining consumer PQ adjustment quantities for each time slot is performed using the optimization method (QP). Process A is an outermost loop, process B is a subsequent loop, and process C is an innermost loop. This results in a reduced number of combinations to be considered, allowing for an efficient optimization process. A description below is based on the three-level hierarchical structure illustrated in FIG. 3; however, FIG. 3 illustrates the example. Processes for determining the variables are not limited to the three-level hierarchical structure illustrated in FIG. 3.

Due to installation maintenance or other reasons in the power system, the open/closed states of the switches may not necessarily remain the same throughout the next day. Therefore, for example, for switches whose open/closed states are specified for each time slot due to maintenance or other reasons, the open/closed states remain as planned values and are not treated as variables.

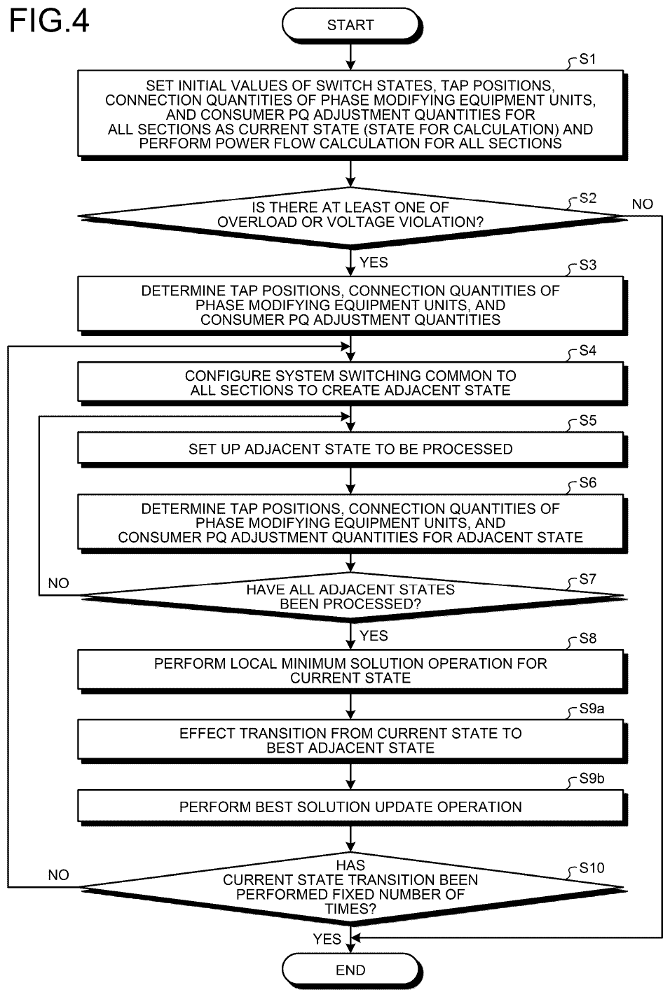

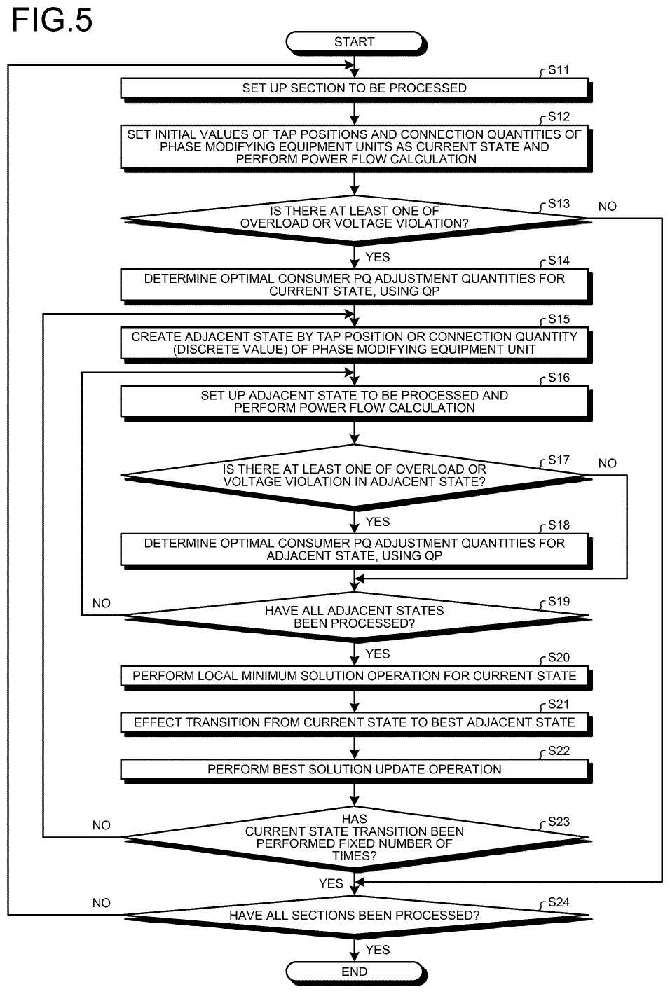

FIGS. 4 and 5 are flowcharts illustrating an example of the power flow calculation process according to the present embodiment. In the example described here, values for the variables are determined for 48 sections (time sections) that represent 30-minute time slots for the next day. As mentioned earlier, the unit of the time slot is not limited to 30 minutes. When a plan for a target period such as one week, one month, or one year is prepared, the target period is divided into days, and the same calculations are performed for each day. In that case, for example, solutions (determined values for each variable) corresponding to a previous day are used as initial values in processing for a subsequent day.

As illustrated in FIG. 4, the power flow calculation unit 25 of the power transmission and distribution operations management system 2 sets the initial values of the switch states, the tap positions, the connection quantities of the phase modifying equipment units, and the consumer PQ adjustment quantities for all the sections as a current state (a state for calculation) and performs power flow calculation for all the sections (step S1). Specifically, the power flow calculation unit 25 uses the switch states, the tap positions, and the connection quantities of the phase modifying equipment units of all the sections, which are indicated in the node and branch states stored in the data storage unit 22, as the initial values to set the current state to the initial values. The initial values for the consumer PQ adjustment quantities are predetermined. For example, these initial values are preset to 0 for all the sections.

Next, the power flow calculation unit 25 determines whether or not results of the power flow calculation performed at step S1 include at least one of an overload or a voltage violation (step S2). If the power flow calculation unit 25 determines Yes at step S2, the power flow calculation unit 25 determines the tap positions, connection quantities of the phase modifying equipment units, and consumer PQ adjustment quantities (step S3). Specifically, the power flow calculation unit 25 performs a process illustrated in FIG. 5, with the open/closed states of the switches of the current state set up. The operation of determining the tap positions, the connection quantities of the phase modifying equipment units, and the consumer PQ adjustment quantities corresponds to processes B and C illustrated in FIG. 3 and will be detailed later. If the power flow calculation unit 25 determines No at step S2, the power flow calculation unit 25 ends the process.

Next, the power flow calculation unit 25 configures a system switching common to all the sections to create an adjacent state (step S4). Specifically, the power flow calculation unit 25 selects one switch that is OFF across all the sections in the current state and changes its open/closed state to the ON state. The power flow calculation unit 25 also selects one switch that is ON across all the sections in the current state and changes its open/closed state to the OFF state. In this way, the power flow calculation unit 25 creates the single adjacent state. Simply changing the switch from the OFF to ON state creates a loop, but the loop is resolved by changing another switch from the ON to OFF state. However, the switch to be changed from the ON to OFF state and the switch to be changed from the OFF to ON state should not be from the transmission system and the distribution system when combined. In other words, when the switch to be changed from the ON to OFF state is a transmission switch, the switch to be changed from the OFF to ON state should also be a transmission switch. When the switch to be changed from the ON to OFF state is a distribution switch, the switch to be changed from the OFF to ON state should also be a distribution switch. As described above, the switches are operated on a daily basis here. Therefore, the open/closed states of the switches are common to all the sections of the single day. The power flow calculation unit 25 changes switches to change from the OFF to ON state and also selects a switch to change from the ON to OFF state to create another adjacent state. By repeating this, the power flow calculation unit 25 creates at least one adjacent state.

Next, the power flow calculation unit 25 sets up an adjacent state to be processed (step S5). Specifically, the power flow calculation unit 25 selects one unprocessed adjacent state (one that has not yet undergone the operation of step S6) from among the adjacent states created at step S4 as the adjacent state to be processed.

Next, the power flow calculation unit 25 determines the tap positions, connection quantities of the phase modifying equipment units, and consumer PQ adjustment quantities for the adjacent state (step S6). Specifically, the power flow calculation unit 25 performs the operation of determining the tap positions, the connection quantities of the phase modifying equipment units, and the consumer PQ adjustment quantities, with the open/closed states of the switches of the adjacent state to be processed set up. The operation of determining the tap positions, the connection quantities of the phase modifying equipment units, and the consumer PQ adjustment quantities corresponds to processes B and C illustrated in FIG. 3, as with step S3.

Next, the power flow calculation unit 25 determines whether or not all the adjacent states have been processed (step S7). Specifically, the power flow calculation unit 25 determines whether or not all the adjacent states created at step S4 have been set up for processing. If all the adjacent states have not been processed, that is to say, if any adjacent states have yet to be processed (No at step S7), the power flow calculation unit 25 performs the operations again, starting from step S5.

If all the adjacent states have been processed (Yes at step S7), the power flow calculation unit 25 performs a local minimum solution operation for the current state (step S8). Specifically, the power flow calculation unit 25 calculates an evaluation value for the current state and evaluation values for all the adjacent states and determines the adjacent state with the best evaluation value, namely the best adjacent state. If the current state is evaluated as being better than the best adjacent state, the power flow calculation unit 25 stores the current state as a local minimum solution, together with its evaluation value. Furthermore, the power flow calculation unit 25 downgrades the evaluation value corresponding to the local minimum solution to continue the search. For example, the power flow calculation unit 25 sets the evaluation value of the best adjacent state as the evaluation value for the local minimum solution used for the search if the current state is evaluated as being better than the best adjacent state. If the current state is evaluated as being worse than the best adjacent state, the power flow calculation unit 25 stores the best adjacent state as the local minimum solution, together with its evaluation value.

Specifically, when, for example, an evaluation function value F(t) for each time section t is expressed by Formula (1) below, the power flow calculation unit 25 calculates a total evaluation function value F_{A} that is the sum of the evaluation function values F(t) over all the time sections, using Formula (2). The power flow calculation unit 25 uses the total evaluation function value F_{A} calculated with Formula (2) as the evaluation value. The smaller the evaluation function value F(t) and the total evaluation function value F_{A}, the better the evaluation.

$$F ( t ) = {F}_{1} ( t ) + {F}_{2} ( t ) + {F}_{3} ( t ) \qquad ( 1 )$$

F₁(t)=Σ(Branch-specific overload quantity (A) squared×Weight coefficient)+Σ(Node-specific voltage deviation quantity (V) squared×Weight coefficient)
F₂(t)=Σ(Consumer-specific P adjustment quantity squared×Weight coefficient)+Σ(Consumer-specific Q adjustment quantity squared×Weight coefficient)
F₃(t)=Transmission loss squared×Weight coefficient+Σ(Switch-specific operation×Weight coefficient)+Σ(Transformer-specific tap change quantity×Weight coefficient)+Σ(Stage count for connection quantity change specific to each phase modifying equipment unit×Weight coefficient)

$${F}_{A} = \sum ( F ( t ) ) \qquad ( 2 )$$

The overload quantity indicates the quantity by which the current (as in power flow) deviates from the allowable limit. The voltage deviation quantity indicates the quantity by which the voltage deviates from the allowable limit. Each weight coefficient is predetermined, for example, in accordance with the power system. In general, the weight coefficients are determined such that each weight coefficient in F₁(t)>each weight coefficient in F₂(t)>each weight coefficient in F₃(t). This is because the degree of avoidance required decreases in the following order:
deterioration in power system quality (overload/voltage deviation)>occurrence of consumer PQ adjustments>system operations (switch operations and tap changes)/transmission loss.

In the above example, the operation of each switch (the number of operations of each switch) is included in F(t). However, since the switches are assumed to be operated on a daily basis, the operation of each switch may be included in F_{A} instead of F(t).

Next, the power flow calculation unit 25 effects a transition from the current state to the best adjacent state (step S9a). Specifically, the power flow calculation unit 25 transitions the current state to the best adjacent state.

Next, the power flow calculation unit 25 performs a best solution update operation (step S9b). In other words, the power flow calculation unit 25 selects the state with the best evaluation value (the smallest evaluation value) from those states set as the current state so far as the best solution and stores the best solution and the corresponding evaluation value. Specifically, the power flow calculation unit 25 compares the stored evaluation value of the best solution with the evaluation value of the current state reached after the transition at step S9a. If the evaluation value of the current state reached after the transition at step S9a is smaller, the power flow calculation unit 25 updates the stored evaluation value of the best solution to reflect the current state reached after the transition at step S9a and the corresponding evaluation value.

Next, the power flow calculation unit 25 determines whether or not the current state transition has been performed a fixed number of times (step S10). Specifically, the power flow calculation unit 25 determines whether or not the operation of step S9a has been performed the predetermined number of times.

If the current state transition has been performed the fixed number of times (Yes at step S10), the power flow calculation unit 25 ends the process. If the current state transition has not been performed the fixed number of times, that is to say, if the current state transition has been performed fewer times than the fixed number of times (No at step S10), the power flow calculation unit 25 performs the operations again, starting from step S4.

FIG. 5 illustrates the process performed at steps S3 and S6 described above, illustrating an exemplary procedure for determining the tap positions, the connection quantities of the phase modifying equipment units, and the consumer PQ adjustment quantities. As illustrated in FIG. 5, the power flow calculation unit 25 sets up a section to be processed (step S11). For example, in a first round at step S11, the power flow calculation unit 25 sets the section to the first time slot of the target period of the control plan. In a second round and onward at step S11, the power flow calculation unit 25 sets the section following the processed section as the section to be processed.

Next, the power flow calculation unit 25 sets the initial values of the tap positions and the connection quantities of the phase modifying equipment units as a current state and performs power flow calculation (step S12). It is to be noted that the open/closed states of the switches correspond to the open/closed states set up for the current state when the process of FIG. 5 is performed as step S3 and to the open/closed states set up for the adjacent state when the process of FIG. 5 is performed as step S6.

Next, the power flow calculation unit 25 determines whether or not there is at least one of an overload or a voltage violation (step S13). If the power flow calculation unit 25 determines No at step S13, the power flow calculation unit 25 determines whether or not all the sections have been processed (step S24). If all the sections have been processed (Yes at step S24), the power flow calculation unit 25 ends the process. If all the sections have not been processed, that is to say, if any sections have yet to be processed (No at step S24), the power flow calculation unit 25 performs the operations again, starting from step S11.

If the power flow calculation unit 25 determines Yes at step S13, the power flow calculation unit 25 determines optimal consumer PQ adjustment quantities for the current state, using QP (step S14). Specifically, the power flow calculation unit 25 uses the PQ adjustable quantities of the consumers as constraints and the evaluation function value F(t) for the single section, which is expressed by above-described Formula (1), as an objective function to determine the optimal consumer PQ adjustment quantities through QP.

Next, the power flow calculation unit 25 creates an adjacent state by the tap position or the connection quantity (discrete value) of the phase modifying equipment unit (step S15). Specifically, the power flow calculation unit 25 creates the single adjacent state by either changing the tap position of one of the transformers by one step or changing the connection quantity of one of the phase modifying equipment units by one stage relative to the current state. The power flow calculation unit 25 creates at least one adjacent state by changing installations to change the tap position or the connection quantity.

Next, the power flow calculation unit 25 sets up an adjacent state to be processed and performs power flow calculation (step S16). Specifically, the power flow calculation unit 25 sets one unprocessed adjacent state among the adjacent states created at step S15 as the state to be processed and performs the power flow calculation for the adjacent state set up to be processed.

Next, the power flow calculation unit 25 determines whether or not there is at least one of an overload or a voltage violation in the adjacent state (step S17). Specifically, the power flow calculation unit 25 uses a result of the power flow calculation performed at step S16 to determine whether or not the adjacent state being processed has the at least one of the overload or the voltage violation.

If the power flow calculation unit 25 determines No at step S17, the power flow calculation unit 25 proceeds to step S19 of the process, which will be described later. If the power flow calculation unit 25 determines Yes at step S17, the power flow calculation unit 25 determines optimal consumer PQ adjustment quantities for the adjacent state, using QP (step S18). Specifically, with the tap positions and the phase modifying equipment units' connection quantities of the adjacent state set up, the power flow calculation unit 25 determines the optimal consumer PQ adjustment quantities through QP, using the PQ adjustable quantities of the consumers as the constraints and the evaluation function value F(t) for the single section, which is expressed by above-described Formula (1), as the objective function.

Next, the power flow calculation unit 25 determines whether or not all the adjacent states have been processed (step S19). If all the adjacent states have not been processed, that is to say, if any adjacent states have yet to be processed among the adjacent states created at step S15 (No at step S19), the power flow calculation unit 25 performs the operations again, starting from step S16.

If all the adjacent states have been processed (Yes at step S19), the power flow calculation unit 25 performs a local minimum solution operation for the current state (step S20), effects a transition from the current state to the best adjacent state (step S21), and performs a best solution update operation (step S22). Steps S20 to S22 are similar to steps S8 to S9b illustrated in FIG. 4, except that the targeted variables change from the open/closed states of the switches to the tap positions of the transformers and the connection quantities of the phase modifying equipment units and that the evaluation value becomes the evaluation function value F(t) for each time section t.

Next, the power flow calculation unit 25 determines whether or not the current state transition has been performed a fixed number of times (step S23). If the current state transition has been performed the fixed number of times (Yes at step S23), the power flow calculation unit 25 proceeds to step S24 of the process. If the power flow calculation unit 25 determines No at step S23, the power flow calculation unit 25 performs the operations again, starting from step S15.

The consumer installations subject to active power (P) and reactive power (Q) adjustment refer to the installations of the consumers who have entered into power adjustment contracts with the aggregator and may be all or some of the consumer installations in the transmission and distribution systems. The consumer installations subject to power adjustment may include those that can be controlled for either the active power or the reactive power, not being limited to the installations that can be adjusted for both the active power and the reactive power. Therefore, the control quantities that the power flow calculation unit 25 determines include, for example, at least one of a control quantity for the active power or a control quantity for the reactive power of the consumer installations. The control quantities that the power flow calculation unit 25 determines may also include at least one of a change to the open/closed state of the switch, a change to the tap position of the transformer, a change to the connection quantity of the phase advancing capacitor(s) of the phase modifying equipment unit, or a change to the connection quantity of the shunt reactor(s) of the phase modifying equipment unit.

The process based on FIGS. 4 and 5 allows the power flow calculation unit 25 to determine the tap positions, the connection quantities of the phase modifying equipment units, and the consumer PQ adjustment quantities as the best solution for each section or time slot and determine the open/closed states of the switches on a daily basis. In other words, the power flow calculation unit 25 performs the calculation process for each combination of the open/closed states of the switches to calculate, through the optimal power flow calculation, the time slot-specific control quantities that correspond to the transformers, the phase modifying equipment units, and the consumer installations and that make specified first evaluation values the best. Furthermore, the power flow calculation unit 25 determines as the control quantities for the installations in the transmission and distribution systems the time slot-specific control quantities that correspond to the transformers, the phase modifying equipment units, and the consumer installations and that make the first evaluation values the best, where the open/closed states of the switches make a second evaluation value the best. For example, the first evaluation value is F(t) expressed by above Formula (1), while the second evaluation value is F_{A} expressed by above Formula (2). In other words, the first evaluation value for each time slot includes, for example, the quantities by which the current deviates from the allowable limits and the quantities by which the voltage deviates from the allowable limits. The second evaluation value is the sum of the first evaluation values over all the time slots. The first evaluation value for each time slot may further include the adjustment quantities for the active power of the consumer installations and the adjustment quantities for the reactive power of the consumer installations. The first evaluation value for each time slot may further include the changes to the tap positions of the transformers, the transmission loss, and the changes to the connection quantities of the phase modifying equipment units. The second evaluation value may further include the number of times each switch is operated.

The procedure illustrated in FIGS. 4 and 5 is an example, and a specific procedure is not limited to this example. The power flow calculation unit 25 stores the determined time slot-specific switch states, tap positions, phase modifying equipment units' connection quantities, and consumer PQ adjustment quantities in the data storage unit 22 as the optimal node and branch states. As described above, the control command generation unit 26 generates the control commands based on the optimal node and branch states, sorts the generated control commands for the transmission system operation management system 1, the distribution system operation management system 3, and the aggregator system 4, and transmits the generated commands to the corresponding units via the transmission and reception unit 21.

As described above, the power transmission and distribution operations management system 2 according to the present embodiment performs optimal power flow calculation across the entire power system, which includes the transmission system and the distribution systems, to calculate control quantities for the installations in the power system (the installations in the transmission system, the installations in the distribution systems, and the consumer installations). This allows for control that uses the installations in the transmission system to resolve an overload or a voltage violation in the distribution system and control that uses the installations in the distribution systems to resolve an overload or a voltage violation in the transmission system, enhancing the ability to solve power quality problems in the power system compared to when the operations of the transmission system and the distribution systems are controlled separately. In addition, since the consumer PQ adjustment quantities are also considered as control targets, overloads or voltage violations that cannot be absorbed by just the transformers and the phase modifying equipment units can be prevented without additional installations.

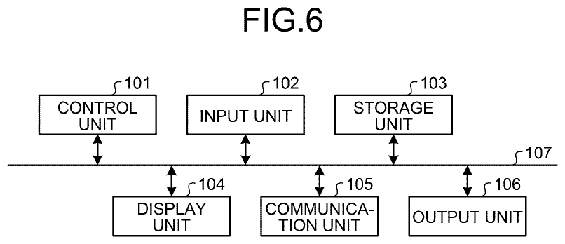

A description is provided next of a hardware configuration of the power transmission and distribution operations management system 2 according to the present embodiment. For the power transmission and distribution operations management system 2 of the present embodiment, a program, namely a computer program describing the operations of the power transmission and distribution operations management system 2, is executed on a computer system. Consequently, the computer system functions as the power transmission and distribution operations management system 2. FIG. 6 is a diagram illustrating an exemplary configuration of the computer system that implements the power transmission and distribution operations management system 2 according to the present embodiment. As illustrated in FIG. 6, this computer system includes a control unit 101, an input unit 102, a storage unit 103, a display unit 104, a communication unit 105, and an output unit 106, all of which are connected via a system bus 107. The control unit 101 and the storage unit 103 constitute processing circuitry.

In FIG. 6, the control unit 101 is, for example, a processor, such as a central processing unit (CPU), and executes the program describing the operations of the power transmission and distribution operations management system 2 according to the present embodiment. The control unit 101 may be partly implemented with dedicated hardware, such as a graphics processing unit (GPU) or a field-programmable gate array (FPGA). The input unit 102 includes, for example, a keyboard and a mouse, among others and is used by a user of the computer system for inputting various information. The storage unit 103 includes various types of memory, such as random access memory (RAM) and read only memory (ROM), and a storage device, such as a hard disk. The storage unit 103 stores the program to be executed by the above control unit 101 and necessary data obtained during the operations, among others. Furthermore, the storage unit 103 is used as a temporary storage area for the program. The display unit 104 is a display, a liquid crystal display (LCD), or another device and displays various screens to the user of the computer system. The display unit 104 and the input unit 102 may be integrated to be implemented as a touch panel or the like. The communication unit 105 is a transmitter and receiver that performs communication processing. The communication unit 105 may include plural devices compatible with plural communication systems, respectively. The output unit 106 is a speaker or another device. FIG. 6 illustrates the example, and the computer system is not limited to the exemplary configuration of FIG. 6.

A description is provided here of an example of how the computer system operates until the program according to the present embodiment becomes executable. The computer program is installed in the storage unit 103 of the computer system with the above-described configuration from, for example, a compact disc (CD)-ROM or a Digital Versatile Disc (DVD)-ROM placed in a CD-ROM or DVD-ROM drive (not illustrated). When executed, the program read from the storage unit 103 is stored in a main storage area of the storage unit 103. In this state, the control unit 101 performs the operations as the power transmission and distribution operations management system 2 of the present embodiment according to the program stored in the storage unit 103.

While the program describing the operations of the power transmission and distribution operations management system 2 is provided on the CD-ROM or the DVD-ROM, which serves as a recording medium, in the above description, this is not limiting. Depending on the computer system configuration, capacity of the program to be provided, and other factors, the program to be used may be provided, for example, via a transmission medium, such as the Internet.

The program according to the present embodiment causes, for example, a computer to execute a step of generating the integrated installation data by use of the transmission system installation data and the distribution system installation data; and a step of determining the control quantities for the installations in the transmission system and the distribution systems by use of the integrated installation data, the power supply and demand forecast data within the transmission system, and the power supply and demand forecast data within the distribution systems for compliance with the at least one of the current constraint or the voltage constraint.

The node and branch integration unit 23, the node and branch state preparation unit 24, the power flow calculation unit 25, and the control command generation unit 26 illustrated in FIG. 1 are implemented when the control unit 101 illustrated in FIG. 6 executes the computer program stored in the storage unit 103 illustrated in FIG. 6. For the implementation of the node and branch integration unit 23, the node and branch state preparation unit 24, the power flow calculation unit 25, and the control command generation unit 26 illustrated in FIG. 1, the storage unit 103 illustrated in FIG. 6 is also used. The transmission and reception unit 21 illustrated in FIG. 1 is implemented with the communication unit 105 illustrated in FIG. 6. The data storage unit 22 illustrated in FIG. 1 is part of the storage unit 103 illustrated in FIG. 6. The power transmission and distribution operations management system 2 may be implemented by plural computer systems. For example, the power transmission and distribution operations management system 2 may be implemented by a cloud system.

For example, the transmission system operation management system 1, the distribution system operation management system 3, and the aggregator system 4 are also implemented by computer systems, such as the one illustrated in FIG. 6. Each of the transmission system operation management system 1, the distribution system operation management system 3, and the aggregator system 4 may also be implemented by plural computer systems. For example, the transmission system operation management system 1, the distribution system operation management system 3, and the aggregator system 4 may be at least partly implemented by a cloud system.

As described above, the power transmission and distribution operations management system 2 according to the present embodiment performs the optimal power flow calculation across the entire power system, which includes the transmission system and the distribution systems, to calculate the control quantities for the installations in the power system. In this way, the ability to solve power quality problems in the power system can be enhanced compared to when the operations of the transmission system and the distribution systems are controlled separately.

### Second Embodiment

Next, a description is provided of a power system operation management system 100 according to a second embodiment. The power system operation management system 100 according to the present embodiment has the same configuration as that of the first embodiment. The following description is mainly of a difference from the first embodiment.

In the example described in the first embodiment, the power transmission and distribution operations management system 2 prepares a control plan that considers both overloads and voltage violations; however, this is not limiting. The power transmission and distribution operations management system 2 may prepare a control plan that considers only either overloads or voltage violations. For example, the power transmission and distribution operations management system 2 may prepare a control plan to prevent overloads, and voltage control may be performed separately for the transmission system and the distribution systems or by another method.

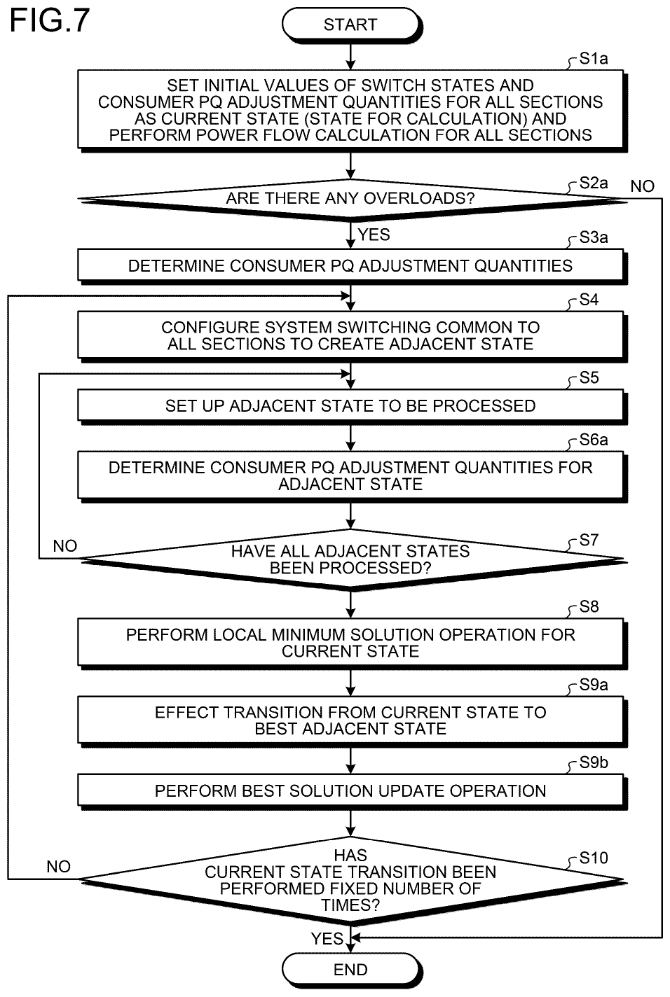

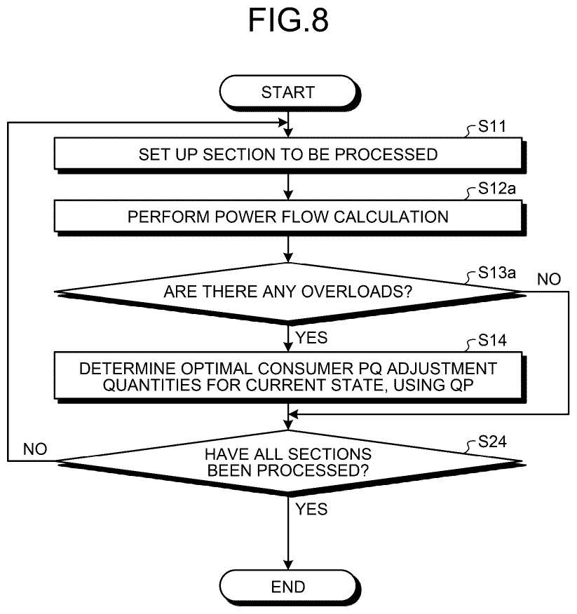

FIGS. 7 and 8 are flowcharts illustrating an example of a power flow calculation process according to the present embodiment. FIGS. 7 and 8 illustrate an example of preparing a control plan to prevent overloads. The power transmission and distribution operations management system 2 operates similarly to the power transmission and distribution operations management system 2 of the first embodiment, except that the power transmission and distribution operations management system 2 performs the process illustrated in FIGS. 7 and 8 instead of the first embodiment's process illustrated in FIGS. 4 and 5.

As illustrated in FIG. 7, the power flow calculation unit 25 sets the initial values of the switch states and the consumer PQ adjustment quantities for all the sections as a current state (a state for calculation) and performs power flow calculation for all the sections (step S1a). Specifically, the power flow calculation unit 25 uses the switch states of all the sections, which are indicated in the node and branch states stored in the data storage unit 22, as the initial values. The power flow calculation unit 25 sets the current state to the initial values, with the initial values for the consumer PQ adjustment quantities set to, for example, 0.

Next, the power flow calculation unit 25 determines whether or not results of the power flow calculation performed at step S1a include any overloads (step S2a). If the power flow calculation unit 25 determines Yes at step S2a, the power flow calculation unit 25 determines consumer PQ adjustment quantities (step S3a). Specifically, the power flow calculation unit 25 performs a process illustrated in FIG. 8, with the open/closed states of the switches of the current state set up. The operation of determining the consumer PQ adjustment quantities corresponds to process C illustrated in FIG. 3 and will be detailed later. If the power flow calculation unit 25 determines No at step S2a, the power flow calculation unit 25 ends the process.

Steps S4 and S5 are identical to those of the first embodiment. After step S5, the power flow calculation unit 25 determines consumer PQ adjustment quantities for the adjacent state (step S6a). Specifically, the power flow calculation unit 25 performs the process illustrated in FIG. 8, with the open/closed states of the switches of the adjacent state set up. Steps S7 to S10 are identical to those of the first embodiment.

As illustrated in FIG. 8, in the operation of determining the consumer PQ adjustment quantities, the power flow calculation unit 25 performs step S11 as in the first embodiment and performs power flow calculation (step S12a). At step S12a, the consumer PQ adjustment quantities are set to the initial values, and the open/closed states of the switches correspond to those of the current state when step S3a is performed and to those of the adjacent state when step S6a is performed. In this example, the tap positions of the transformers and the connection quantities of the phase modifying equipment units are not variables; therefore, values from the node and branch states or planned values specified, for example, in voltage control plans may be used. If the phase modifying equipment unit state data and the tap position data within the transmission and distribution systems are planned values specified in the voltage control plans, using the node and branch states reflects the voltage control plans.

The power flow calculation unit 25 determines whether or not there are any overloads (step S13a). If the power flow calculation unit 25 determines No at step S13a, the power flow calculation unit 25 proceeds to step S24 of the process. If the power flow calculation unit 25 determines Yes at step S13a, the power flow calculation unit 25 proceeds to step S14 of the process. Steps S14 and S24 are identical to those of the first embodiment. In the example illustrated in FIGS. 7 and 8, the power flow calculation unit 25 does not need to include items related to the switches, the changes to the tap positions, and the connection quantities of the phase modifying equipment units, as well as an item related to the node-specific voltage deviation quantities, in Formula (1) when calculating an evaluation value.

Through the process illustrated in FIGS. 7 and 8, the power transmission and distribution operations management system 2 according to the present embodiment can determine the open/closed states of the switches and the consumer PQ adjustment quantities to prevent overloads across the entire power system, which includes the transmission system and the distribution systems.

The power transmission and distribution operations management system 2 may prepare a control plan to prevent voltage violations, and control for preventing overloads may be performed separately for the transmission system and the distribution systems or by another method. In that case, variables in optimal power flow calculation may be the open/closed states of the switches, the tap positions of the transformers, and the connection quantities of the phase modifying equipment units. Additionally, the consumer Q (reactive power) may also be used for voltage control, in which case the consumer PQ adjustment quantities are included as variables.

As described above, the power transmission and distribution operations management system 2 only needs to determine control quantities for the installations in the transmission and distribution systems by performing the power flow calculations across the entire power system where the transmission system and the distribution systems are integrated, to prevent at least one of an overload or a voltage violation. In this way, the ability to solve power quality problems in the power system can be enhanced compared to when the transmission system and the distribution systems are operated separately.

The above configurations illustrated in the embodiments are illustrative, can be combined with other techniques that are publicly known, and can be partly omitted or changed without departing from the gist. The embodiments can be combined with each other.

### REFERENCE SIGNS LIST

1 transmission system operation management system; 2 power transmission and distribution operations management system; 3 distribution system operation management system; 4 aggregator system; 11, 21, 31, 41 transmission and reception unit; 12, 22, 32, 42 data storage unit; 13 transmission system installation control unit; 23 node and branch integration unit; 24 node and branch state preparation unit; 25 power flow calculation unit; 26 control command generation unit; 33 distribution system installation control unit; 43 consumer installation control unit; 100 power system operation management system; 201 top-level-substation primary-side bus; 202 top-level transformer; 203 transmission transformer; 204, 216 phase modifying equipment unit; 205, 209 transmission switch; 206 transmission line; 207, 214 load; 208, 215 power generation installation; 210 distribution-substation primary-side bus; 211 distribution transformer; 212, 217 distribution switch; 213 distribution line; 218 SVR.

1. A power transmission and distribution operations management apparatus comprising:
an integration circuitry to generate integrated installation data including both installations in a transmission system and installations in a distribution system, using transmission system installation data and distribution system installation data, the transmission system installation data being data about the installations in the transmission system, the distribution system installation data being data about the installations in the distribution system; and
a control quantity determination circuitry to determine control quantities for the installations in the transmission system and the distribution system, using the integrated installation data, power supply and demand forecast data within the transmission system, and power supply and demand forecast data within the distribution system, for compliance with at least one of a current constraint or a voltage constraint.

2. The power transmission and distribution operations management apparatus according to claim 1, wherein
the installations include consumer installations as installations of consumers, and
control quantities for the installations include at least one of a control quantity for active power or a control quantity for reactive power of the consumer installations.

3. The power transmission and distribution operations management apparatus according to claim 2, wherein
the installations include switches in the transmission system and the distribution system, and
control quantities for the installations include changes to open or closed states of the switches.

4. The power transmission and distribution operations management apparatus according to claim 3, wherein
the installations include transformers in the transmission system and the distribution system, and
control quantities for the installations include changes to tap positions of the transformers.

5. The power transmission and distribution operations management apparatus according to claim 4, wherein
the installations include phase modifiers in the transmission system and the distribution system, and
control quantities for the installations include changes to connection quantities of phase advancing capacitors and shunt reactors of the phase modifiers.

6. The power transmission and distribution operations management apparatus according to claim 5, wherein the control quantity determination circuitry determines changes to open or closed states of the switches on a daily basis and determines the control quantities corresponding to the transformers, the phase modifiers, and the consumer installations for each of time slots that are divisions of one day.

7. The power transmission and distribution operations management apparatus according to claim 6, wherein the control quantity determination circuitry performs a calculation process for each of combinations of open or closed states of the switches to calculate, through optimal power flow calculation, the time slot-specific control quantities that correspond to the transformers, the phase modifiers, and the consumer installations and that make first evaluation values being specified the best and determines as control quantities for the installations in the transmission system and the distribution system the time slot-specific control quantities that correspond to the transformers, the phase modifiers, and the consumer installations and that make the first evaluation values the best, where open or closed states of the switches make a second evaluation value the best.

8. The power transmission and distribution operations management apparatus according to claim 7, wherein
the control quantity determination circuitry determines control quantities for the installations in the transmission system and the distribution system for compliance with at least one of the current constraints and at least one of the voltage constraints,
the first evaluation values are respectively for the time slots and each include how much current deviates from allowable limits and how much voltage deviates from allowable limits, and
the second evaluation value is sum of the first evaluation values over all the time slots.

9. The power transmission and distribution operations management apparatus according to claim 8, wherein each of the first evaluation values that are respectively for the time slots further includes adjustment quantities for active power of the consumer installations and adjustment quantities for reactive power of the consumer installations.

10. The power transmission and distribution operations management apparatus according to claim 9, wherein each of the first evaluation values that are respectively for the time slots further includes changes to the tap positions, transmission loss, and changes to the connection quantities of the phase modifiers.

11. The power transmission and distribution operations management apparatus according to claim 10, wherein the second evaluation value further includes switch operation counts.

12. A power system operation management system comprising:
a transmission system operation management system to manage a transmission system;
a distribution system operation management system to manage a distribution system; and
a power transmission and distribution operations management apparatus, wherein
the power transmission and distribution operations management apparatus includes
a transceiver to receive transmission system installation data from the transmission system operation management system and distribution system installation data from the distribution system operation management system, the transmission system installation data being data about installations in the transmission system, the distribution system installation data being data about installations in the distribution system,
an integration circuitry to generate integrated installation data including both the installations in the transmission system and the installations in the distribution system, using the transmission system installation data and the distribution system installation data, and
a control quantity determination circuitry to determine control quantities for the installations in the transmission system as well as in the distribution system, using the integrated installation data, power supply and demand forecast data within the transmission system, and power supply and demand forecast data within the distribution system, for compliance with at least one of a current constraint or a voltage constraint, and
the transceiver transmits, among the installations, the control quantities for the installations in the transmission system to the transmission system operation management system and the control quantities for the installations in the distribution system to the distribution system operation management system.

13. The power system operation management system according to claim 12, comprising:
an aggregator system to manage consumers, wherein
the installations include consumer installations as installations of the consumers,
control quantities for the installations include at least one of a control quantity for active power or a control quantity for reactive power of the consumer installations, and
the transceiver transmits, among the installations, the control quantities for the consumer installations to the aggregator system.

14. A power system operation management method for a power transmission and distribution operations management apparatus, the power system operation management method comprising:
generating, by use of transmission system installation data and distribution system installation data, integrated installation data including both installations in a transmission system and installations in a distribution system, the transmission system installation data being data about the installations in the transmission system, the distribution system installation data being data about the installations in the distribution system; and
determining control quantities for the installations in the transmission system and the distribution system by use of the integrated installation data, power supply and demand forecast data within the transmission system, and power supply and demand forecast data within the distribution system, for compliance with at least one of a current constraint or a voltage constraint.

15. A non-transitory computer-readable storage medium having a program stored therein, the program for causing a computer system to execute:
generating, by use of transmission system installation data and distribution system installation data, integrated installation data including both installations in a transmission system and installations in a distribution system, the transmission system installation data being data about the installations in the transmission system, the distribution system installation data being data about the installations in the distribution system; and
determining control quantities for the installations in the transmission system and the distribution system by use of the integrated installation data, power supply and demand forecast data within the transmission system, and power supply and demand forecast data within the distribution system, for compliance with at least one of a current constraint or a voltage constraint.
